(19) United States
(12) Patent Application Publication
(10) Pub. No.: US 2006/0085350 A1
(43) Pub. Date: Apr. 20, 2006

(54) Enterprise-wide flexible software licensing model

(75) Inventors: Mallikarjuna Samayamantry, Boca Raton, FL (US); Nissim Ozery, Parkland, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Networks, Inc.

(21) Appl. No.: 10/951,355

(22) Filed: Sep. 28, 2004

(51) Int. Cl. G06Q 99/00

(52) U.S. Cl. 705/59

(57) ABSTRACT

Methods according to preferred embodiments of the present invention include establishing a licensing component on a plurality of servers, where each licensing component has a count of licenses. Each server is in communication with at least one other server on the network. When a server requires more licenses than are available according to its count, it sends a request to the other servers via the network. A server with surplus licenses responds to the request and supplies the requesting server with additional licenses. Further aspects of the invention include systems, software license models, and methods for implementing flexible software license models, which may utilize the aforementioned methods of the present invention.

### BACKGROUND OF THE INVENTION

1. Field of the Invention

This invention relates to software systems that require multiple licenses. More particularly, this invention relates to systems and methods for transferring licenses from one server to another via a network connecting the servers.

2. Brief Description of the Prior Art

Enterprises must maintain software licenses for each of their employees that use software. When personnel are moved from one location to another, licenses must be moved with them. This is a tedious manual process that is subject to many problems.

Licensing for software systems, in the simplest form, is performed on a per system basis. Each system installed at a customer site has its own licensing resource (usually a license file) and all the licensing needs for the system's operation and configuration are met by this system specific licensing resource. For the purpose of discussion, this licensing model is referred to herein as the Localized Licensing Model.

Another popular licensing technique is the Centralized Licensing Model. This model is more prevalent when the customer site has multiple software systems installed. According to this model, a centralized license server, which may also be called the license repository, operates as the sole licensing authority and all software servers that need to authenticate licensing requests point to this central server for their individual licensing needs. A variant of this model may be referred to as the Semi-centralized Licensing Model. The network is divided into sub-nets, wherein each sub-net has a licensing repository or licensing server and all software servers within the sub-net point to the licensing server in that sub-net.

Each of the above-described licensing techniques have their own disadvantages. In the case of the localized licensing model, the major restriction is the portability of licenses from one server to another.

For example, consider a site that has three thousand licenses spread across ten servers and the number of licenses per server is fixed in each of the individual license files. If a server which originally needed one hundred licenses now needs two hundred licenses, at least two license files must be reconfigured to allow for this change. Since the licenses in the system are usually based on users, such moves are not uncommon. This model will also involve frequent modifications to license files across the systems in which they are installed. Moreover, the maintenance effort and downtime involved in reinstalling the modified license files may be considerable.

The major disadvantage with the centralized licensing model is that it creates a single point of failure for the network or sub-net as the case may be. If the licensing server encounters downtime for any reason, all servers that are dependent on this licensing server for their licensing needs will be directly affected and may be inoperable during the downtime. Such a scenario may be considered unacceptable for any major software server network environment.

### SUMMARY OF THE INVENTION

It is therefore an object of the invention to provide a software licensing model.

It is also an object of the invention to provide a software licensing model that has the advantages of a Centralized licensing Model but not the disadvantages.

It is another object of the invention to provide a software licensing model that has the advantages of a Localized Licensing Model but not the disadvantages.

It is yet another object of the invention to provide a software licensing model that does not require supervision or manual intervention.

It is yet another object of the invention to provide a software licensing model where licenses are automatically transferred from one location to another.

It is another object of the invention to provide a software licensing model where downtime of license servers is minimized.

It is still another object of the invention to provide a software licensing model that does not have a single point of failure.

These and other object of the invention are provided in accordance with the principles of the present invention by providing an enterprise-wide flexible software licensing model. Systems and methods according to preferred embodiments of the present invention may include the steps of and components for establishing a licensing component on a plurality of servers; establishing communication between the plurality of servers via a communications/data network; generating a licensing request on a server that requires more licenses than are present on that server; transmitting the licensing request to one or more servers located on the communications/data network; receiving the licensing request by one or more servers on the communications/data network; determining whether any of the servers receiving the licensing request have available licenses to respond to the licensing request; and transferring available licenses from one or more servers to the requesting server via the communications/data network.

### BRIEF DESCRIPTION OF THE DRAWINGS

The above and other objects and advantages of the present invention will be apparent upon consideration of the following detailed description, taken in conjunction with the accompanying drawings, in which like reference numbers refer to like parts throughout, and in which:

FIG. 1 shows a generalized block diagram of the present invention illustrating two servers each connected to the network with each server having one hundred users and one hundred licenses; and

FIG. 2 shows a generalized block diagram of the present invention illustrating two servers each connected to the network with one server having seventy-five users and one hundred licenses and the other server having one hundred twenty-five users and one hundred licenses.

FIG. 2A shows a generalized block diagram of the present invention illustrating three servers each connected to the network with a first server having fifty users and twenty five licenses, a second server having one hundred users and one hundred ten licenses, and a third server having one hundred users and one hundred fifteen licenses.

FIG. 3 shows a flow chart according to a preferred embodiment of the present invention.

### DETAILED DESCRIPTION

Systems and methods according to preferred embodiments of the present invention may include the steps of and components for establishing a licensing component on a plurality of servers; establishing communication between the plurality of servers via a communications/data network; generating a licensing request on a server that requires more licenses than are present on that server; transmitting the licensing request from the requesting server to one or more or all servers located on the communications/data network; receiving the licensing request by one or more servers on the communications/data network; determining whether any server receiving the licensing request has available licenses to respond to the licensing request and determining how many of these licenses to send to the requesting server; and transferring available licenses from one or more servers to the requesting server via the communications/data network.

Each licensing component on the server may include a count of licenses that may be used for one or more types of software being utilized on network. Each server may be made aware of the other and may be located on one more interconnected communications/data networks.

The systems and methods according to the preferred embodiment of the present invention may operate as follows: When a server requires more licenses than it has according to its count, that server may send a licensing request to other servers located on the communications/data network. A server with surplus licenses may respond to the request and supply the requesting server with additional licenses based upon a predetermined algorithm or any other suitable set of criteria. The request may be broadcast to all servers on the communications/data network or may be made by sending one or more individual requests to a particular server on the network.

Communication among servers may be accomplished via LDAP (Lightweight Directory Access Protocol), Active Directory (for Microsoft Windows operating systems), or by any other suitable communications/data protocol.

The preferred embodiments of the present invention assume that the total number of licenses in the enterprise is sufficient to cover all of the employees requiring such licenses. This way, whenever an employee is mobile (e.g., temporarily relocated) or transferred from one site to another, the license server at the new location may provide a license for the employee by obtaining a license from the license server at the employee's former location.

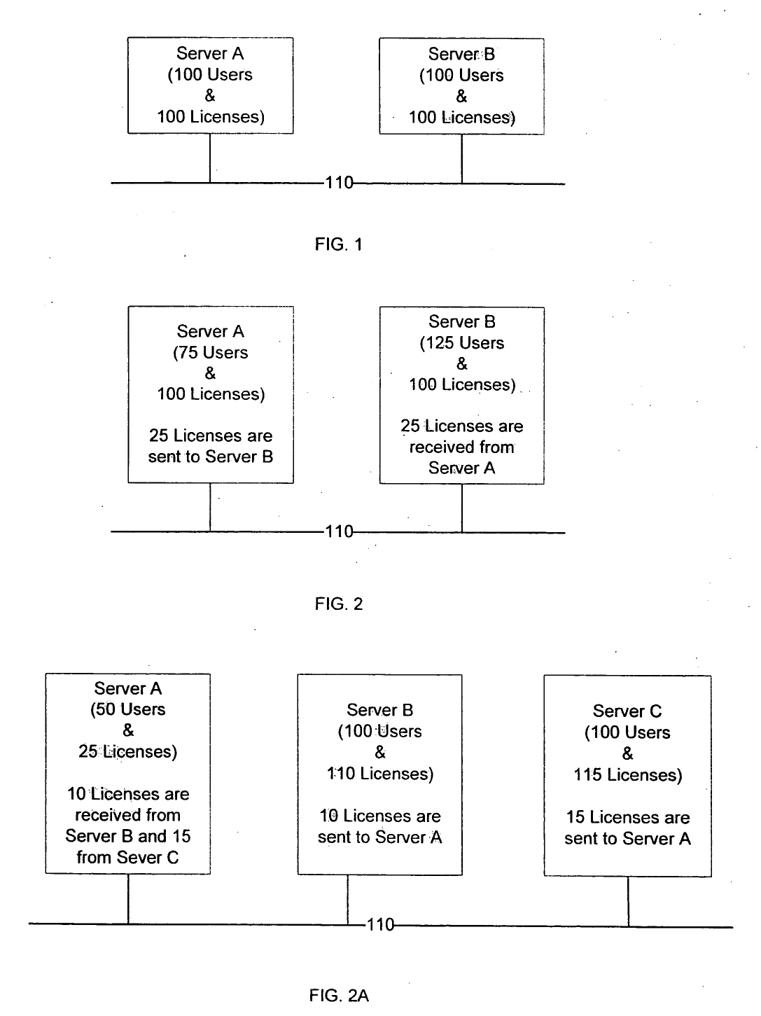

FIGS. 1 and 2 show an illustrative example of the operation of the present invention with reference to two servers (Server A and Server B) coupled to communications/data network 110. FIG. 2A show an illustrative example of the operation of the present invention with reference to three servers (Server A, Server B, and Server C) coupled to communications/data network 110. More particularly, FIG. 1 shows the condition where Server A and Server B each have one hundred users and one hundred licenses; FIG. 2 shows the condition of the servers after twenty-five users are transferred from Server A to Server B; and FIG. 2A shows the condition of the three servers after twenty-five users are transferred from Server B and Server C to Server A.

In the scenario of FIG. 2, Server B would not be able to fulfill the licensing needs of the additional twenty-five users. All servers including Server B may include equipment, one or more algorithms, or other suitable types of software that are designed to monitor and detect when additional licenses are needed. Such equipment/software may also be used to generate a licensing request to poll other severs on the network in order to determine whether surplus licenses are available on the other servers on the network. It should also be mentioned that this equipment/software may be remotely located from the servers on the network. Therefore, in accordance with the principles of the present invention, Server B may send a licensing request via communications/data network 110 to Server A requesting twenty-five additional licenses.

Since Server A has twenty-five surplus licenses, it may respond to the license request of Server B and transfer the surplus licenses. In this manner, though the users have relocated across servers within a network, the licensing resources need not undergo any changes to accommodate for these relocations. In order to determine whether a server has surplus licenses, the server may include equipment, one or more algorithms, or other suitable types of software that are designed to monitor and detect when surplus licenses are located on a particular server. Such equipment/software may also be used to transfer surplus licenses in response to a particular server's licensing request. It should also be mentioned that this equipment/software may be remotely located from the servers on the network.

In the scenario of FIG. 2A, Server A would not be able to fulfill the licensing needs of the additional twenty-five users. As mentioned above with respect to Server B, Server A in this scenario may include equipment, one or more algorithms, or other suitable types of software that are designed to monitor and detect when additional licenses are needed. Such equipment/software may also be used to generate a licensing request to poll other severs on the network in order to determine whether surplus licenses are available on the other servers on the network. It should also be mentioned that this equipment/software may be remotely located from the servers on the network. Therefore, in accordance with the principles of the present invention, Server A may send a licensing request via communications/data network 110 to the other servers on network 110 (e.g., Server B and Server C) requesting twenty-five additional licenses. In this scenario, since Server B has ten surplus licenses and Server C has fifteen surplus licenses, they may respond to the license request of Server A and transfer their surplus licenses to Server A.

One particular advantage of the present invention is that downtime on any one particular server will not affect the operability of other servers on the network. For example, in the scenario described in FIG. 2, if Server A were to encounter downtime, one hundred users of Server B would still be able to function, and if Server B were to encounter downtime, the seventy-five users on Server A will still be operational. Likewise, in the scenario in FIG. 2A, if Server A were to encounter downtime, one hundred users of Server B and one hundred users of Server C will still be operational.

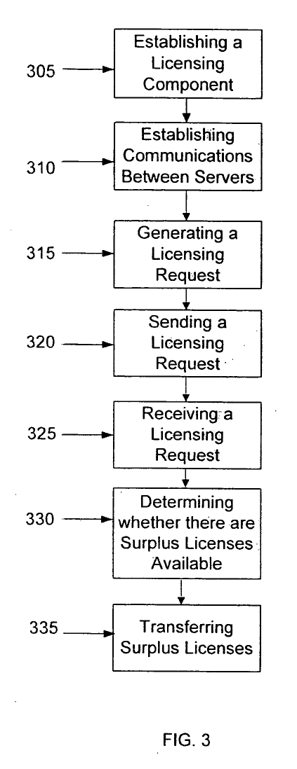

FIG. 3 shows a flow chart according to a preferred embodiment of the present invention for transferring licenses between a first server and second server via a communications/data network connecting the two servers. At step 305, a licensing component may be established on a first server and a second server. The licensing component may include a count of licenses that corresponds to the number of users requiring a license on each particular server. At step 310, communication between the first server and the second server may be established via communications/data network 110 (shown in FIGS. 1 and 2). At step 315, a licensing request may be generated from the first server to the second server when the licensing component of the first server requires more licenses than are present in first server's licensing count. At step 320, the licensing request may be sent from the first server to the second server via the communications/data network. At step 325, the licensing request may be received at the second server. At step 330, the second server may determine whether it has available licenses in its count to respond to the first server's licensing request. Finally, at step 335, available licenses may be transferred from the second server to the first server in response the first server's licensing request.

The following is a comparison between the invention and the prior art licensing models:

The Localized Licensing Model

In this model, user moves made across servers would require new license files to be created/configured on both the old and the new servers. However, the effects of downtime may be minimized because each server stands independently of every other server. Therefore, even if one server experiences downtime, users of other servers may still operate normally. However, in the preferred model of the present invention, new license files do not need to be created/configured, thus, overcoming the disadvantage of the Localized Licensing Model. In addition, as described above, the effects of a downtime are also minimized.

The Centralized License Model

In this model, a user relocation to a new server does not have an effect on the allocation of licenses, as a centralized server holds all of the licenses that are necessary for the users on the network. However, the effect of downtime may be severe if the server that is acting as the licensing server were to encounter downtime. For example, if a downtime occurs on the centralized licensing server all of the users that obtain licenses from that server will not be able function. On the other hand, in the preferred model of the present invention, licenses are automatically transferred as needed but remain distributed over several servers. Thus, under the model of the present invention, the effect of downtime on a single server does not have a global impact.

Therefore, systems and methods for providing an enterprise-wide flexible software licensing model are provided. It will be understood that the foregoing is only illustrative of the principles of the present invention and that various modifications may be made by those skilled in the art without departing from the scope and spirit of the present invention. Accordingly, such embodiments are presented for the purposes of illustration rather than limitation and that the present invention is only limited by the claims that follow.

What is claimed is:

1. A method for transferring licenses between a plurality of servers via a network connecting the servers, the method comprising the steps of:
establishing a licensing component on the plurality servers, wherein each licensing component includes a count of licenses that corresponds to the number of users requiring a license on each particular server;
establishing communication between the plurality of servers via the network;
generating a licensing request from one or more servers when the licensing component of the requesting server requires more licenses than are present in the requesting server's counts;
sending the licensing request via the network from the requesting server;
receiving the licensing request by one or more servers on the network and determining whether the receiving server has available licenses in its count to respond to the requesting server's licensing request; and
transferring available licenses via the network from one or more receiving servers in response to the licensing request of the requesting server.

2. The method according to claim 1, wherein the licensing request is broadcast to a plurality of servers on the network.

3. The method according to claim 1, wherein the licensing request is transmitted to a one or more particular servers on the network.

4. The method according to claim 1, wherein communication among servers is accomplished via a Lightweight Directory Access Protocol.

5. The method according to claim 1, wherein communication among servers is accomplished via an Active Directory for Microsoft Windows operating system.

6. A system for transferring licenses between a plurality of servers via a network connecting the plurality of servers comprising:
a plurality of servers coupled to the network, wherein each server includes a licensing component having a count of licenses and a count of users requiring licenses, and wherein each server's licensing component is in communication with each other;
means for determining whether a particular server requires a greater count of licenses than are present in that server's licensing component;
means for generating and sending a licensing request when a server requires more licenses than are present in its count of licenses;
means for receiving a licensing request and determining whether a particular server contains surplus licenses; and
means for transmitting surplus licenses between the plurality of servers.

7. The system according to claim 6, wherein the licensing request is broadcast to a plurality of servers on the network.

8. The system according to claim 6, wherein the licensing request is transmitted to a one or more particular servers on the network.

9. The method according to claim 6, wherein communication among servers is accomplished via a Lightweight Directory Access Protocol.

10. The method according to claim 6, wherein communication among servers is accomplished via an Active Directory for Microsoft Windows operating system.

11. A software licensing model, comprising:
a plurality of servers coupled to a network, wherein each server includes a licensing component, and wherein licenses are automatically transferred as needed but remain distributed over several servers.

12. The software licensing model according to claim 11, wherein downtime of a single server does not affect all users.

13. The software licensing model according to claim 11, wherein it is not necessary to configure new license files when a user is transferred from one server to another.

14. The software licensing model according to claim 13, wherein there is no single point of failure that has a global impact on the network.

15. A method for implementing a flexible software licensing model across a plurality of servers coupled to a network, each server having a licensing component, comprising the steps of:
automatically transferring licenses as needed between servers; and
maintaining a distribution of licenses across the plurality of servers.

16. The method according to claim 15, further comprising the step of protecting servers from a single server downtime event whereby not all users on the network are affected by the single server downtime event.

17. The method according to claim 15, wherein it is not necessary to configure new license files when a user is transferred from one server to another.

18. The method according to claim 15, wherein there is no single point of failure.
